(19) United States
(12) Patent Application Publication
(10) Pub. No.: US 2023/0362609 A1
(43) Pub. Date: Nov. 9, 2023

(54) BLUETOOTH TRANSMITTER, BLUETOOTH RECEIVER, AND RECEIVER

(71) Applicant: Airoha Technology Corp., Hsinchu City (TW)

(72) Inventors: Yun-Xuan ZHANG, Taipei City (TW); Tzu-Kuan YANG, Hsinchu City (TW)

(21) Appl. No.: 17/737,095

(22) Filed: May 5, 2022

(51) Int. Cl. H04W 4/80; H04L 1/00

(52) U.S. Cl. CPC H04W 4/80; H04L 1/0002

(57) ABSTRACT

A Bluetooth transmitter, a Bluetooth receiver, and a receiver are provided. The Bluetooth transmitter includes modulation modules, up-conversion modules, and an RF transmitting circuit. The modulation modules modulate transmission bitstreams to generate multiple pairs of modulated signals. The up-conversion modules up-convert the pairs of modulated signals to multiple pairs of up-converted signals. The RF transmitting circuit transmits an output signal based on the pairs of up-converted signals. The Bluetooth receiver includes an RF receiving circuit, down-conversion modules, and de-modulators. The RF receiving circuit transforms an input signal into a pair of analog filtered signals. The down-conversion modules generate pairs of down-converted signals based on the pair of analog filtered signals. The de-modulators generate received bitstreams by demodulating the pairs of down-converted signals.

### TECHNICAL FIELD

The disclosure relates in general to a Bluetooth transmitter, a Bluetooth receiver, and a receiver, and more particularly to a Bluetooth transmitter, a Bluetooth receiver, and a receiver capable of improving data transmission quality and data transmission rate.

### BACKGROUND

Bluetooth wireless technology is a popular short-range technology used for data communication between electronic devices. In Bluetooth specification, an electronic device having a Bluetooth controller and relative peripherals is defined as a Bluetooth device.

Frequency-hopping spread spectrum (hereinafter, FHSS) technology has been adopted in Bluetooth to reduce the chance of unwanted interference. Bluetooth standard divides the frequency band into radio-frequency (hereinafter, RF) channels, and the definition of bandwidth and the number of RF channels are different in different versions of Bluetooth standard. In Bit Rate/Enhanced Data Rate (hereinafter, BR/EDR) technology, 79 RF channels are defined and used for data transmission. In low energy (hereinafter, LE) technology, 40 RF channels are defined, three of them are used for broadcast. Therefore, 37 RF channels can be used for data transmission in LE technology.

In practical applications, the RF channels being selected for data transmission are based on Bluetooth specifications, and the bandwidth of each RF channel is dependent on the Bluetooth version. For example, each RF channel in BR/EDR technology is of 1MHz wide, and each RF channel in LE technology is 2 MHz wide. In the specification, the RF channels being utilized for data transmission are defined as data channels datCh. The number of data channels available for data transmission is 79 in BR/EDR technology or 37 in LE technology, but only 15 data channels are concerned in the specification for the sake of illustration.

FIG. 1 is a schematic diagram illustrating the frequency distribution of data channels datCh1 to datCh15. The frequency corresponding to the data channel labeled with a smaller number is lower than the frequency corresponding to the data channel labeled with a greater number. For example, the frequency corresponding to data channel datCh1 is lower than the frequency corresponding to data channel datCh2, and so forth. Please note that the data channels with a consecutive number might or might not correspond to consecutive RF channels.

Although Bluetooth adopts FHSS to reduce the effects caused by environmental interference, the data transmission might still be interfered with. FIG. 2 is a schematic diagram illustrating the exemplary distribution of the interference areas. Please note that the distribution and the number of the interference areas in the practical environment may vary.

Two interference areas 18a and 18b are shown for illustration purposes. The interference area 18a covers data channels datCh11, datCh12, datCh13 and datCh14 from interval T1 to interval T4. The interference area 18b covers data channels datCh4, datCH5, datCh6 and datC7 from interval T3 to interval T5. The interference areas 18a and 18b might overlap the transmission path of data packets between Bluetooth devices and result in packet loss. Therefore, the data transmission approach defined in Bluetooth specification needs further improvement.

### SUMMARY

The disclosure is directed to a Bluetooth transmitter, a Bluetooth receiver, and a receiver capable of improving data transmission quality and data transmission rate.

According to one embodiment, a Bluetooth transmitter is provided. The Bluetooth transmitter includes a modulation stage, an up-conversion stage, a first-path digital-to-analog converter, a second-path digital-to-analog converter, and a radio frequency transmitting circuit.

The modulation stage includes a first modulation module and a second modulation module. The first modulation module corresponds to a first selected channel and the second modulation module corresponds to a second selected channel. The first modulation module modulates a first transmission bitstream to generate a first first-path modulated signal and a first second-path modulated signal. The second modulation module modulates a second transmission bitstream to generate a second first-path modulated signal and a second second-path modulated signal. The up-conversion stage includes a first up-conversion module and a second up-conversion module. The first up-conversion module corresponds to a first selected channel and the second up-conversion module corresponds to a second selected channel. The first up-conversion module is electrically connected to the first modulation module. The first up-conversion module up-converts the first first-path modulated signal to a first first-path up-converted signal, and up-converts the first second-path modulated signal to a first second-path up-converted signal. The second up-conversion module is electrically connected to the second modulation module. The second up-conversion module up-converts the second first-path modulated signal to a second first-path up-converted signal, and up-converts the second second-path modulated signal to a second second-path up-converted signal. The first-path digital-to-analog converter generates a first-path baseband signal based on the first first-path up-converted signal and the second first-path up-converted signal. The second-path digital-to-analog converter generates a second-path baseband signal based on the first second-path up-converted signal and the second second-path up-converted signal. The radio frequency transmitting circuit is electrically connected to the first-path digital-to-analog converter and the second-path digital-to-analog converter. The radio frequency transmitting circuit generates an output signal based on the first-path baseband signal and the second-path baseband signal. The output signal represents a plurality of data packets in a plurality of intervals.

According to another embodiment, a Bluetooth receiver is provided. The Bluetooth receiver includes a radio frequency receiving circuit, a first-path analog-to-digital converter, a second-path analog-to-digital converter, a down-conversion stage, and a demodulation stage. The radio frequency receiving circuit receives an input signal and transforms the input signal into a first-path analog filtered signal and a second-path analog filtered signal. The input signal represents a plurality of data packets in a plurality of intervals. The first-path analog-to-digital converter and the second-path analog-to-digital converter are electrically connected to the radio frequency receiving circuit. The first-path analog-to-digital converter converts the first-path analog filtered signal to a first-path digital filtered signal. The second-path analog-to-digital converter converts the second-path analog filtered signal to a second-path digital filtered signal. The down-conversion stage includes a first down-conversion module and a second down-conversion module. The first down-conversion module corresponds to a first selected channel, and the second down-conversion module corresponds to a second selected channel. The first down-conversion module is electrically connected to the first-path analog-to-digital converter and the second-path analog-to-digital converter. The first down-conversion module down-converts the first-path digital filtered signal to a first first-path down-converted signal and down-converts the second-path digital filtered signal to a first second-path down-converted signal. The second down-conversion module is electrically connected to the first-path analog-to-digital converter and the second-path analog-to-digital converter, The second down-conversion module down-converts the first-path digital filtered signal to a second first-path down-converted signal, and down-converts the second-path digital filtered signal to a second second-path down-converted signal, The demodulation stage includes a first de-modulator and a second de-modulator. The first dc-modulator corresponds to the first selected channel, and the second de-modulator corresponds to the second selected channel. The first de-modulator is electrically connected to the first down-conversion module. The first de-modulator provides a first received bitstream based on the first first-path down-converted signal and the first second-path down-converted signal. The second de-modulator is electrically connected to the second down-conversion module. The second de-modulator provides a second received bitstream based on the second first-path down-converted signal and the second second-path down-converted signal.

According to an alternative embodiment, a receiver is provided, The receiver includes a radio frequency circuit, a first de-modulator, and a second de-modulator. The radio frequency circuit receives an input signal originating from radio waves transmitted on a first channel and a second channel. The first de-modulator provides a first bitstream based on a first data packet transmitted on the first channel and without a second data packet transmitted on the second channel. The second de-modulator provides a second bitstream different from the first bitstream based on the second data packet transmitted on the second channel and without the first data packet transmitted on the first channel.

### BRIEF DESCRIPTION OF THE DRAWINGS

FIG. 1 (prior art) is a schematic diagram illustrating the frequency distribution of the data channels.

FIG. 2 (prior art) is a schematic diagram illustrating the exemplary distribution of the interference areas.

FIG. 3A is a schematic diagram illustrating that the Bluetooth communication system with a one-to-one scheme utilizes one data channel in an interval for data transmission.

FIG. 3B is a schematic diagram illustrating how the interference areas affect the data transmission in FIG. 3A.

FIG. 4A is a schematic diagram illustrating the contents of the data packets in FIG. 3A are split into several portions.

FIG. 4B is a schematic diagram illustrating that the Bluetooth communication system with a one-to-one scheme utilizes multiple data channels in an interval for data transmission.

FIG. 5A is a schematic diagram illustrating an exemplary data channel allocation based on which the master device transmits multiple data packets in the same interval to a single slave device.

FIG. 5B is a schematic diagram illustrating how the interference areas affect data transmission in FIG. 5A.

FIG. 6A is a schematic diagram illustrating another exemplary data channel allocation based on which the master device transmits multiple data packets in the same interval to a single slave device.

FIG. 6B is a schematic diagram illustrating how the interference areas disturb the data transmission in FIG. 6A.

FIG. 7A is a schematic diagram illustrating that the Bluetooth communication system with a one-to-many scheme utilizes one data channel in an interval for data transmission.

FIG. 7B is a schematic diagram illustrating how the interference areas affect the data transmission in FIG. 7A.

FIG. 8A is a schematic diagram illustrating that the master device in the Bluetooth communication system with a one-to-many scheme utilizes multiple data channels in an interval for data transmission.

FIGS. 8B and 8C are schematic diagrams illustrating the slave devices in the Bluetooth communication with a one-to-many scheme to acquire their corresponding data packets from the input signal rxS.

FIG. 9A is a schematic diagram illustrating an exemplary data channel allocation based on which the master device transmits multiple data packets in the same interval to multiple slave devices.

FIG. 9B is a schematic diagram illustrating how the interference areas affect data transmission in FIG. 9A.

FIG. 10 is a block diagram illustrating the internal components of the Bluetooth transmitter according to an embedment of the present disclosure.

FIG. 11 is a block diagram illustrating the internal components of the Bluetooth receiver according to an embedment of the present disclosure.

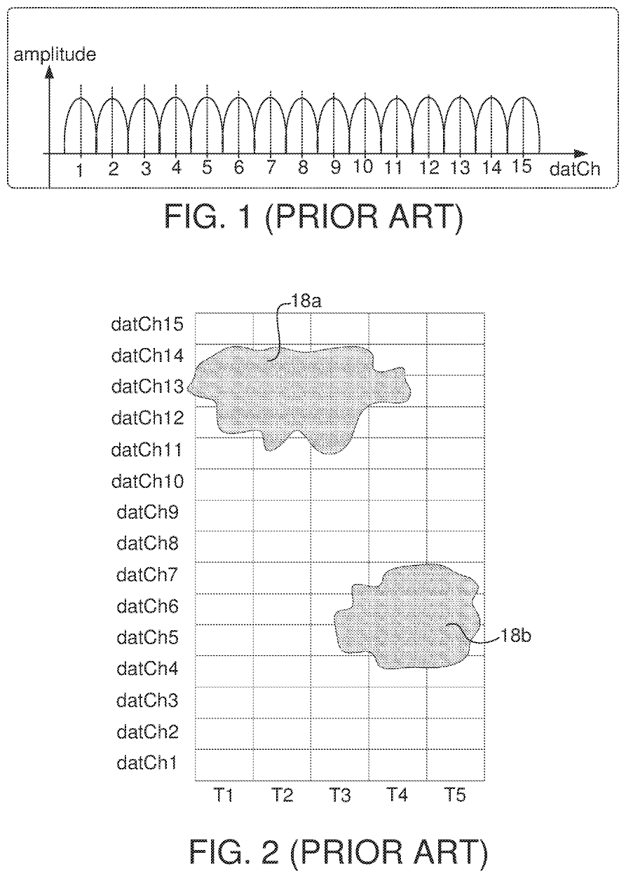

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

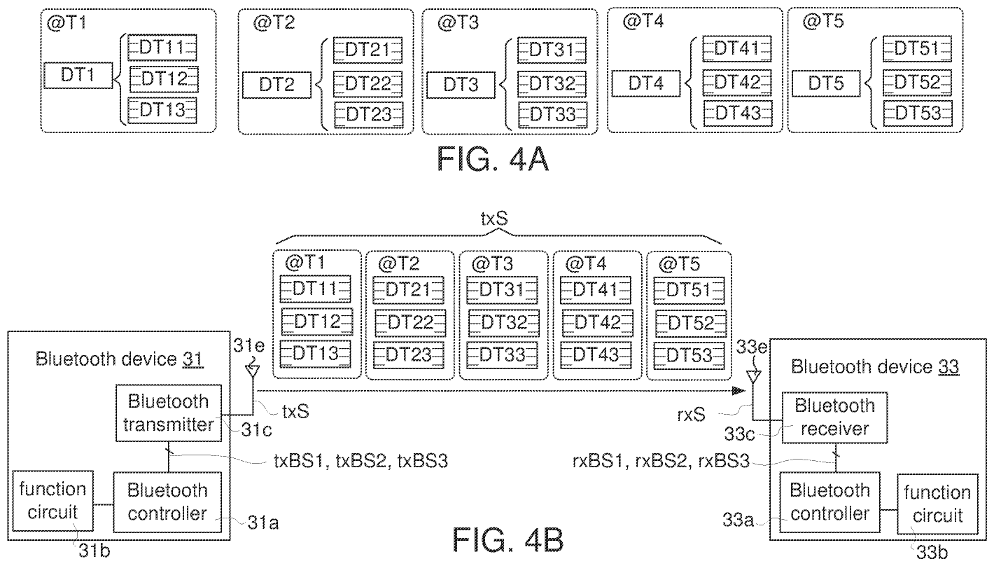

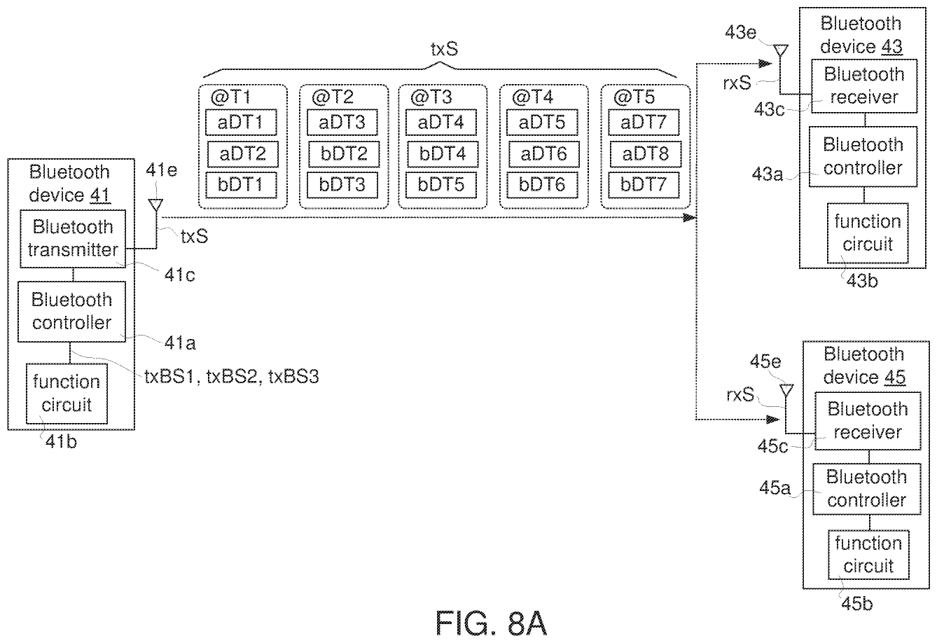

The application scenarios in that Bluetooth devices proceed with data transmission can be classified into two schemes. In the first scheme, a master device transmits data packets to one slave device (one-to-one scheme). In the second scheme, a master device transmits data packets to multiple slave devices (one-to-many scheme). For both schemes, the data packets are transmitted through radio waves, and the interference areas might cause data loss. FIGS. 3A, 3B, 4A, 4B, 5A, 5B, 6A and 6B are related to the one-to-one scheme, and FIGS. 7A, 7B, 8A, 8B, 8C, 9A and 9B are related to the one-to-many scheme.

FIG. 3A is a schematic diagram illustrating that the Bluetooth communication system with a one-to-one scheme utilizes one data channel in an interval for data transmission. In FIG. 3A, the Bluetooth device 11 is a master device, and the Bluetooth device 13 is a slave device. The Bluetooth device 11 sequentially transmits data packets DT1, DT2, DT3, DT4 and DT5 on different data channels to the Bluetooth device 13. The number labeled at the suffix of symbol of data packets represents the order or sequence of data packets.

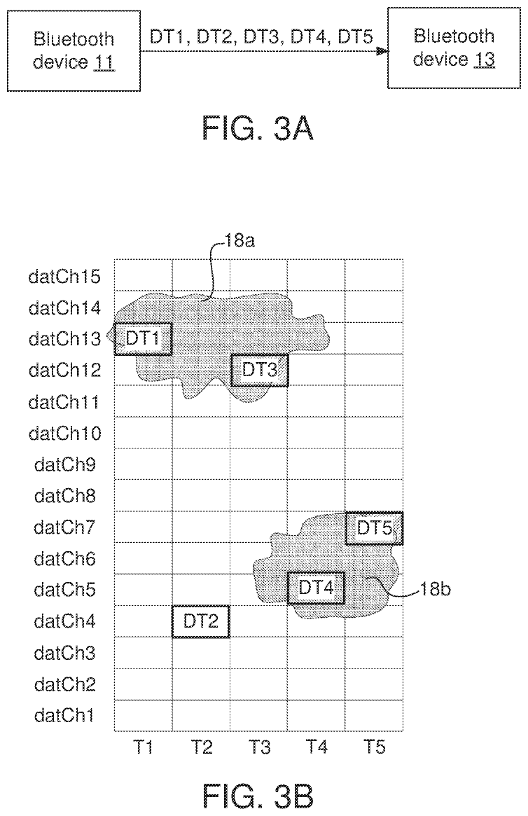

FIG. 3B is a schematic diagram illustrating how interference affects the data transmission in FIG. 3A. The interference areas 18a and 18b in FIG. 2 are reproduced in FIG. 3B, together with the details about how the master device allocates data channels and schedules the transmission of data packets in FIG. 7A. Please refer to FIGS. 3A and 3B together.

The Bluetooth device 11 transmits the data packets DT1, DT2, DT3 and DT4 in a frequency hopping manner. The Bluetooth device 11 transmits the data packet DT1 on data channel datCh13 in interval T1, transmits the data packet DT2 on data channel datCh4 in interval T2, transmits the data packet DT3 on data channel datCh12 in interval T3, transmits the data packet DT4 on data channel datCh5 in interval T4, and transmits the data packet DT5 on data channel datCh7 in interval T5.

The interference area 18a overlaps the data packets DT1 and DT3, and the interference area 18b overlaps the data packets DT4 and DT5. Therefore, the Bluetooth device 13 can receive only the data packet DT2, but not the data packets DT1, DT3, DT4 and DT5.

Instead of transmitting one data packet in one interval, a master device can transmit M data packets in one interval. Alternatively speaking, M data channels are selected at the same time to transmit the M data packets together. The variable M is a positive number, and M is greater than 1 (M>1). In the following embodiments, it is assumed that M=3.

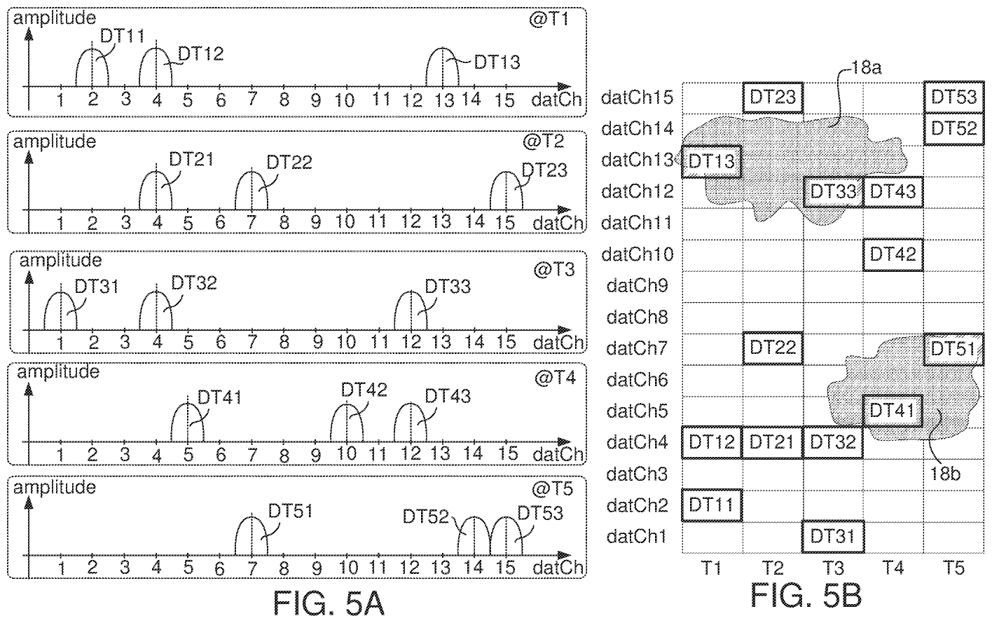

FIG. 4A is a schematic diagram illustrating the content of the data packets in FIG. 3A is split into several portions. The content of data packet DT1 in FIGS. 3A and 3B are split or divided into M portions, and each of these M portions is encapsulated as an individual data packet DT11, DT12 and DT13. Similarly, the content of each of data packets DT2, DT3, DT4 and DT5 are divided and encapsulated, as shown in Table 1.

TABLE 1

| | | Interval during which |
|---|---|---|
| data packets in | data packets in | data packet(s) are |
| FIGS. 3A and 3B | FIGS. 4A and 4B | transmitted |
| DT1 | DT11, DT12, DT13 | T1 |
| DT2 | DT21, DT22, DT23 | T2 |
| DT3 | DT31, DT32, DT33 | T3 |
| DT4 | DT41, DT42, DT43 | T4 |
| DT5 | DT51, DT52, DT53 | T5 |

FIG. 4B is a schematic diagram illustrating that the Bluetooth communication system with a one-to-one scheme utilizes multiple data channels in an interval for data transmission. The Bluetooth device 31 is a master device, and the Bluetooth device 33 is a slave device. The Bluetooth device 31 includes a function circuit 31b, a Bluetooth controller 31a, a Bluetooth transmitter 31c, and an antenna 31e. The Bluetooth device 33 includes a function circuit 33b, a Bluetooth controller 33a, a Bluetooth receiver 33c, and an antenna 33e. The Bluetooth controller 31a can be considered as a bridge or an interface circuit between the function circuits 31b and the Bluetooth transmitter 31c, and the Bluetooth controller 33a can be considered as a bridge or an interface circuit between the function circuit 33b and the Bluetooth receiver 33c. When the function circuits 31a and 33a need Bluetooth-related applications, the Bluetooth controllers 31a and 33a respond the requirement from the function circuits 31a and 33a, perform Bluetooth-related operations and proceed with subsequent operations accordingly.

The Bluetooth controller 31a provides transmission bitstreams txBS1, txBS2 and txBS3 to the Bluetooth transmitter 31c. As previously mentioned, the content of a data packet is split into several portions. As such, the transmission bitstream txBS1 carries a first portion of the data packet, the transmission bitstream txBS2 carries a second portion of the data packet, and the bitstream txBS3 carries a third portion of the data packet, wherein the first portion, the second portion and the third portion are different from each other. Therefore, the transmission bitstreams txBS1, txBS2 and txBS3 are different from each other. Based on the transmission bitstreams txBS1, txBS2 and txBS3, the Bluetooth transmitter 31c generates an output signal txS, and the antenna 31e radiates radio waves in the air based on the output signal txS. The output signal txS carries data packets DT11, DT12 and DT13 in interval T1, carries data packets DT21, DT22 and DT23 in interval T2, carries data packets DT31, DT32 and DT33 in interval T3, carries data packets DT41 DT42 and DT43 in interval T4, and carries data packets DT51, DT52 and DT53 in interval T5.

The antenna 33e receives radio waves in the air and conducts an input signal rxS to the Bluetooth receiver 33c based on the radio waves. The Bluetooth receiver 33c transforms the input signal rxS to received bitstreams rxBS1, rxBS2 and rxBS3 to the Bluetooth controller 33a.

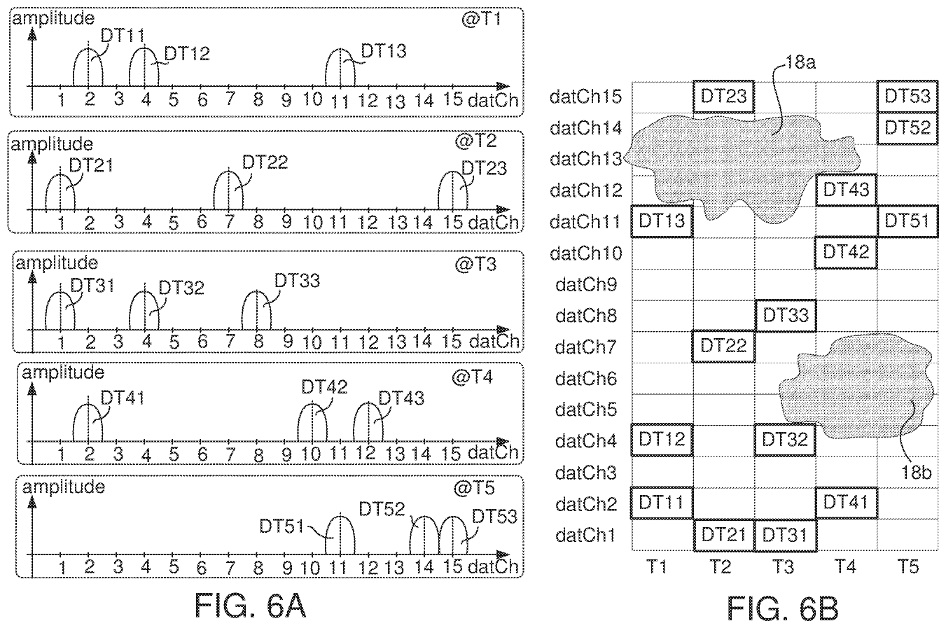

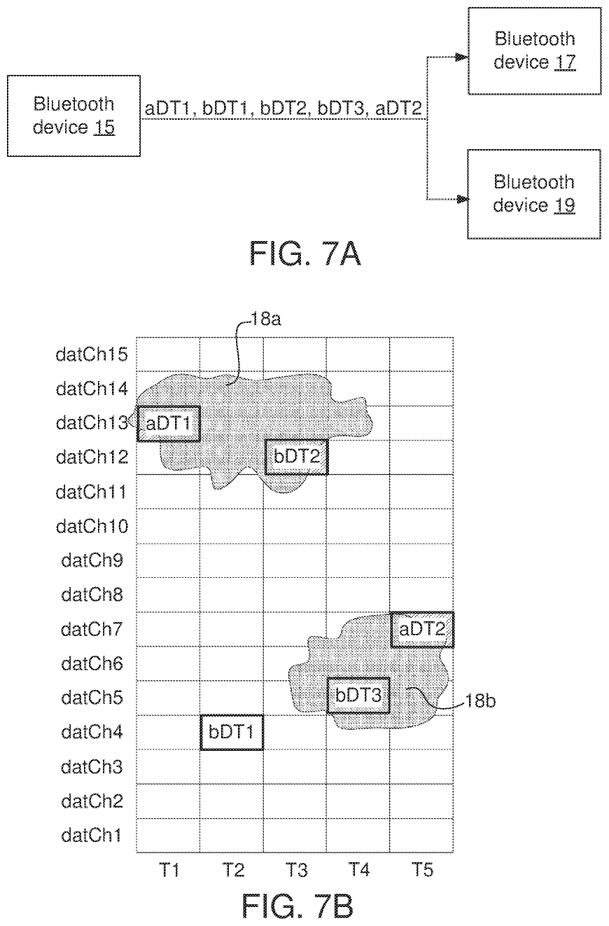

The Bluetooth device 31 selects M (assuming M=3) of data channels datCh1 to datCh15 in each interval for simultaneously transmitting M data packets in the interval. The data channels being selected in the same interval are defined as selected channels sCh1, sCh2 and sCh3. The selection of the selected channels sCh1, sCh2 and sCh3 is random and not limited. FIGS. 5A and 5B demonstrate a possible sequence for channel selection and FIGS. 6A and 6B demonstrate another possible sequence for channel selection.

In FIGS. 5B and 6B, the bold frames represent which of the data channels datCh1 to datCh15 are selected for data transmission in different intervals T1 to T5. The data channels being selected for data transmission are labeled with their corresponding data packets. In each interval T1 to T5, three data channels are selected, and frequencies corresponding to these selected data channels are ordered in ascending order. In FIGS. 5B and 6B, how do the interference areas 18a and 18b affect the data transmission in FIGS. 5A and 6A are demonstrated.

FIG. 5A is a schematic diagram illustrating an exemplary data channel allocation based on which the master device transmits multiple data packets in one interval to a single slave device. FIG. 5B is a schematic diagram illustrating how the interference areas affect data transmission in FIG. 5A. Please refer to FIGS. 5A and 5B together.

During interval T1, the output signal txS carries data packets DT11 DT12 and DT13 being transmitted on data channels datCh2, datCh4 and datCh13. The data channels datCh2, datCh4 and datCh13 are respectively considered as selected channels sCh1, sCh2, and sCh3 in interval T1.

During interval T2, the output signal txS carries data packets DT21, DT22 and DT23 being transmitted on data channels datCh4, datCh7 and datCh15. The data channels datCh4, datCh7 and datCh15 are respectively considered as selected channels sCh1, sCh2 and sCh3 in interval T2.

During interval T3, the output signal txS carries data packets DT31 DT32 and DT33 being transmitted on data channels datCh1, datCh4, and datCh12. The data channels datCh1, datCh4, and datCh12 are respectively considered as selected channels sCh1, sCh2, and sCh3 in interval T3.

During interval T4, the output signal txS carries data packets DT41, DT42 and DT43 being transmitted on data channels datCh5, datCh10, and datCh12. The data channels datCh5, datCh10 and datCh12 are respectively considered as selected channels sCh1, sCh2 and sCh3 in interval T4.

During interval T5, the output signal txS carries data packets DT51, DT52 and DT53 being transmitted on data channels datCh7, datCh14 and datCh15. The data channels datCh4, datCh7 and datCh15 are respectively considered as selected channels sCh1, sCh2 and sCh3 in interval T5.

As shown in FIG. 5B, the interference areas 18a and 18b overlap some of the data packets in intervals T1 to T5. The interference area 18a overlaps the data packets DT13 and DT33, and the interference area 18b overlaps the data packets DT41 and DT51. Therefore, the data packets DT13, DT33, DT41 and DT51 cannot be successfully received nor recovered by the Bluetooth device 33. On the other hand, there are still some data packets DT11, DT12, DT21, DT22, DT23, DT31, DT32, DT42, DT43, DT52 and DT53 that can be successfully received by the Bluetooth device 33 Alternatively speaking, with the multiple selected channels sCh1, sCh2 and sCh3, the data packets get a better chance to be successfully received.

Assuming that the data packets include audio data, the remained data packets allow the user to continuously listen to the music without interruption, even if the audio quality might be slightly affected by the packet loss.

FIG. 6A is a schematic diagram illustrating another exemplary data channel allocation based on which the master device transmits multiple data packets in one interval to a single slave device. FIG. 6B is a schematic diagram illustrating how the interference areas disturb the data transmission in FIG. 6A. Please refer to FIGS. 6A and 6B together.

During interval T1, the output signal txS carries data packets DT11, DT12 and DT13 being transmitted on data channels datCh2, datCh4 and datCh11. The data channels datCh2, datCh4 and datCh11 are respectively considered as selected channels sCh1, sCh2 and sCh3 in interval T1.

During interval T2, the output signal txS carries data packets DT21, DT22 and DT23 being transmitted on data channels datCh1, datCh7 and datCh15. The data channels datCh1, datCh7 and datCh15 are respectively considered as selected channels sCh1, sCh2 and sCh3 in interval T2.

During interval T3, the output signal txS carries data packets DT31, DT32 and DT33 being transmitted on data channels datCh1, datCh4 and datCh8. The data channels datCh1, datCh4 and datCh8 are respectively considered as selected channels sCh1, sCh2 and sCh3 in interval T3.

During interval T4, the output signal txS carries data packets DT41, DT42 and DT43 being transmitted on data channels datCh2, datCh10 and datCh12. The data channels datCh2, datCh10 and datCh12 are respectively considered as selected channels sCh1, sCh2 and sCh3 in interval T4.

During interval T5, the output signal txS carries data packets DT51, DT52 and DT53 being transmitted on data channels datCh11, datCh14 and datCh15. The data channels datCh11, datCh14 and datCh15 are respectively considered as selected channels sCh1, sCh2 and sCh3 in interval T5.

As shown in FIG. 6B, the interference areas 18a and 18b do not overlap any of the data packets DT11, DT12, DT13, DT21, DT22, DT23, DT31, DT32, DT33, DT41, DT42, DT43, DT51, DT52 and DT53. This implies that the slave device can successfully receive all data packets DT11, DT12, DT13, DT21, DT22, DT23, DT31, DT32, DT33, DT41, DT42, DT43, DT51, DT52 and DT53. As three data channels are simultaneously utilized for data transmission, the data transmission rate can be improved as well.

For the one-to-one scheme, an exemplary allocation of selected channels sCh1, sCh2 and sCh3 and data packets in intervals T1 to T5 are summarized in Table 2. Please refer to FIGS. 5A, 5B, 6A, and 6B and Table 2 together.

TABLE 2

| | interval | | | | |
|---|---|---|---|---|---|
| selected channel | T1 | T2 | T3 | T4 | T5 |
| sCh1 | DT11 | DT21 | DT31 | DT41 | DT51 |
| sCh2 | DT12 | DT22 | DT32 | DT42 | DT52 |
| sCh3 | DT13 | DT23 | DT33 | DT43 | DT53 |

FIG. 7A is a schematic diagram illustrating that the Bluetooth communication system with a one-to-many scheme utilizes one data channel in an interval for data transmission. The Bluetooth device 15 is a master device, and the Bluetooth devices 17 and 19 are slave devices. The Bluetooth device 15 sequentially transmits data packets aDT1, bDT1, bDT2, bDT3 and aDT2.

For the sake of identification, data packets corresponding to the Bluetooth device 17 have the prefix “a”, and data packets corresponding to the Bluetooth device 19 have the prefix “b”. Similarly, the number at the suffix of symbol of data packets represent the order or sequence of the data packets. Thus, the data packet aDT1 represents a first data packet corresponding to the Bluetooth device 17. The representation of other symbols of the data packets aDT2, bDT1 and bDT2 are similar.

FIG. 7B is a schematic diagram illustrating how the interference areas affect the data transmission in FIG. 7A. The interference areas 18a and 18b in FIG. 2 are reproduced in FIG. 7B, together with the details about how the master device allocates data channels and schedules transmission of the data packets in FIG. 7A. Please refer to FIGS. 7A and 7B together.

The Bluetooth device 15 transmits data packet aDT1 on data channel datCh13 in interval T1, transmits data packet bDT1 on data channel datCh4 in interval T2, transmits data packet bDT2 on data channel datCh12 in interval T3, transmits data packet bDT3 on data channel datCh5 in interval T4, and transmits data packet aDT2 on data channel datCh7 in interval T5. The data packets aDT1 and aDT2 correspond to the Bluetooth device 17, and the data packets bDT1 bDT2 and bDT3 correspond to the Bluetooth device 19.

FIG. 7B shows that the interference area 18a overlaps the data packets aDT1 and bDT2, and the interference area 18b overlaps the data packets bDT3 and aDT2. Therefore, the Bluetooth device 17 cannot receive any of its corresponding data packets aDT1 and aDT2. Moreover, the Bluetooth device 19 can only receive the data packet bDT1, not the data packets bDT2 and bDT3.

Instead of transmitting one data packet to one of the slave devices in one interval, the master device can transmit M data packets to one or more slave devices in one interval, The M data packets may correspond to one or multiple slave devices. Alternatively speaking, M data channels are selected at the same time to transmit the M data packets together. The variable M is a positive number, and M is greater than 1 (M>1). In the following embodiments, it is assumed that M=3.

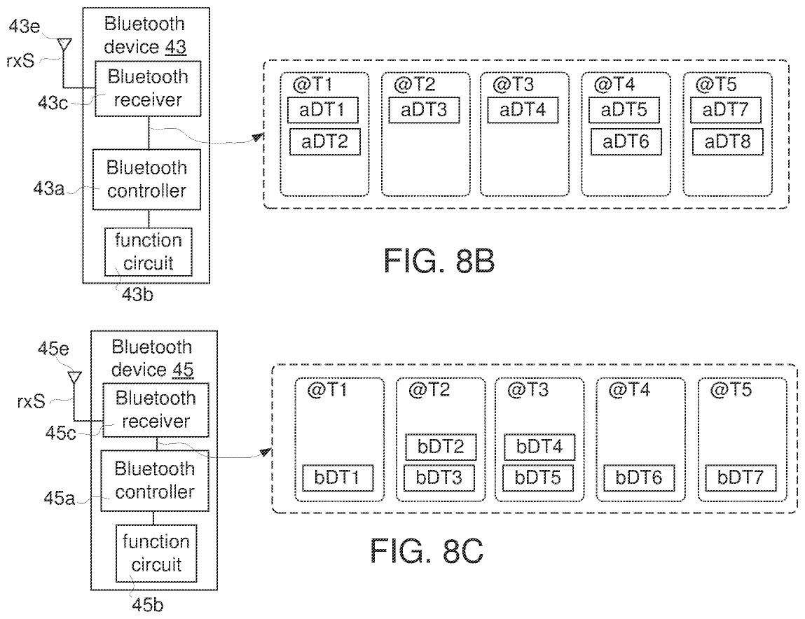

FIG. 8A is a schematic diagram illustrating that the master device in the Bluetooth communication system with a one-to-many scheme utilizes multiple data channels in an interval for data transmission. The Bluetooth device 41 is a master device, and the Bluetooth devices 43 and 45 are slave devices. The Bluetooth device 41 includes a function circuit 41b, a Bluetooth controller 41a, a Bluetooth transmitter 41c, and an antenna 41e. The Bluetooth device 43 includes a function circuit 43b, a Bluetooth controller 43a, a Bluetooth receiver 43c, and an antenna 43e. The Bluetooth device 45 includes a function circuit 45b, a Bluetooth controller 45a, a Bluetooth receiver 45c, and an antenna 45e. Similarly, the Bluetooth controllers 41a, 43a and 45a can be considered as a bridge or interface circuits between the function circuits 41b, 43b and 45b and the Bluetooth transmitter 41c or the Bluetooth receivers 43c and 45c. The content of data packets individually carried by the transmission bitstreams txBS1, txBS2 and txBS3 is originated from the different data sources. For example, the transmission bitstream txBS1 is originated from an audio stream, and the transmission bitstream txBS2 is originated from a video stream. Alternatively, the transmission bitstream txBS1 is originated from a first audio stream, and the transmission bitstream txBS2 is originated from a second audio stream different from the first audio stream. As a result, the transmission bitstreams txBS1, txBS2 and txBS3 are different from each other.

The label of data packets are based on the definitions illustrated above. The symbol representing data packets corresponding to the Bluetooth device 43 are labeled with the prefix “a”, and the symbol representing data packets corresponding to the Bluetooth device 45 are labeled with the prefix “b.” The number at the suffix of symbol of data packets represent the order or sequence of the data packets.

During interval T1, the output signal txS carries data packets aDT1, aDT2 and bDT1. During interval T2, the output signal txS carries data packets aDT3, bDT2 and bDT3. During interval T3, the output signal txS carries data packets aDT4, bDT4 and bDT5. During time interval T4, the output signal txS carries data packets aDT5, aDT6 and bDT6. During time interval T5, the output signal txS carries data packets aDT7, aDT8 and bDT7.

FIGS. 8B and 8C are schematic diagrams illustrating the slave devices in the Bluetooth communication with a one-to-many scheme to acquire their corresponding data packets from the input signal rxS. According to the embodiment of the present disclosure, Bluetooth devices 43 and 45 receive radio waves in the air, and generates the input signal rxS based on the radio waves. Then, the Bluetooth receiver 43c could extract the data packets aDT1 to aDT8 corresponding to the Bluetooth device 43 from the input signal rxS, and the Bluetooth receiver 45c could extract the data packets bDT1 to bDT7 corresponding to the Bluetooth device 45 from the input signal rxS.

From the Bluetooth receiver 43c, the Bluetooth controller 43a receives the received bitstreams rxS to acquire contents of data packets aDT1 and aDT2 in interval T1, data packet aDT3 in interval T2, data packet aDT4 in interval T3, data packets aDT5 and aDT6 in interval T4, and data packets aDT7 and aDT8 in interval T5. From the Bluetooth receiver 45c, the Bluetooth controller 45a receives bitstreams to acquire contents of data packet bDT1 in interval T1, data packets bDT2 and bDT3 in interval T2, data packets bDT4 and bDT5 in interval T3, data packet bDT6 in interval T4, and data packet bDT7 in interval T5.

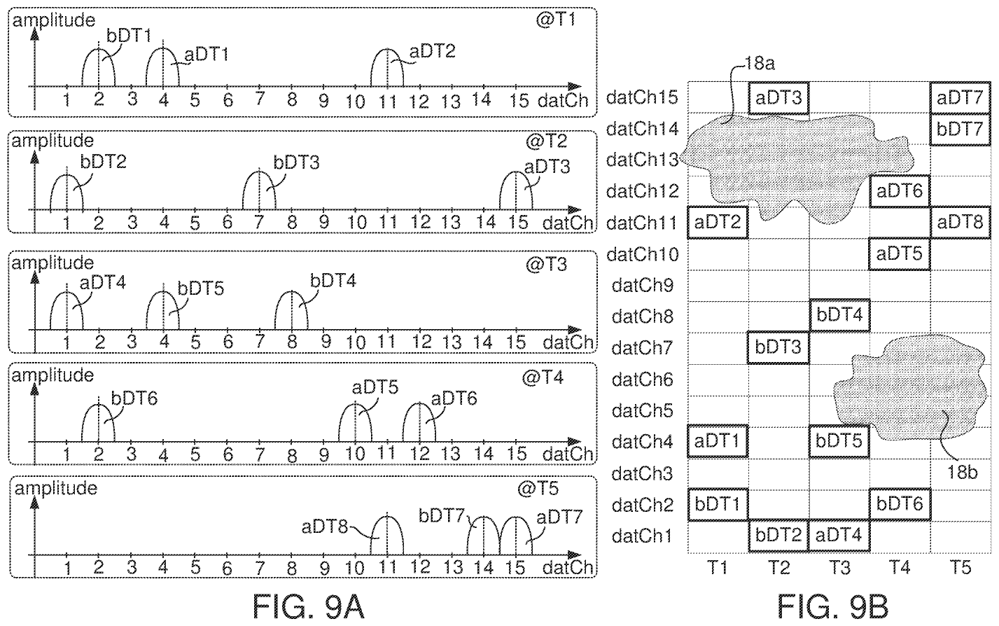

To summarize, FIG. 8B shows that the Bluetooth device 43 could receive data packets aDT1 to aDT8 during intervals T1 to T5 and FIG. 8C shows that the Bluetooth device 45 could receive data packets bDT1 to bDT7 during intervals T1 to T5. FIGS. 8A, 8B and 8C demonstrate that the different slave devices (Bluetooth devices 43 and 45) can receive their own data packets in the same duration as the Bluetooth transmitter 41c transmits multiple data packets in each interval T1 to T5. FIGS. 9A and 9B demonstrate a possible sequence for channel selection in FIGS. 8A, 8B and 8C.

FIG. 9A is a schematic diagram illustrating an exemplary data channel allocation based on which the master device transmits multiple data packets in one interval to multiple slave devices. FIG. 9B is a schematic diagram illustrating how the interference areas affect data transmission in FIG. 9A. Please refer to FIGS. 8A, 8B, 80, 9A and 9B together.

During interval T1 the output signal rxS carries data packets bDT1, aDT1 and aDT2 being transmitted on data channels datCh2, datCh4 and datCh11. The data channels datCh2, datCh4 and datCh1 are respectively considered as selected channels sCh1, sCh2 and sCh3 in interval T1.

During interval T2, the output signal rxS carries data packets bDT2, bDT3 and aDT3 being transmitted on data channels datCh1, datCh7 and datCh15. The data channels datCh1, datCh7 and datCh15 are respectively considered as selected channels sCh1, sCh2 and sCh3 in interval T2.

During interval T3, the output signal rxS carries data packets aDT4, bDT5 and bDT4 being transmitted on data channels datCh1, datCh4 and datCh8. The data channels datCh1, datCh4 and datCh8 are respectively considered as selected channels sCh1, sCh2 and sCh3 in interval T3.

During interval T4, the output signal rxS carries data packets bDT6, aDT5 and aDT6 being transmitted on data channels datCh2, datCh10 and datCh12. The data channels datCh2, datCh10 and datCh12 are respectively considered as selected channels sCh1, sCh2 and sCh3 in interval T4.

During interval T5, the output signal rxS carries data packets aDT8, bDT7 and aDT7 being transmitted on data channels datCh11, datCh14 and datCh15. The data channels datCh11, datChl4 and datCh15 are respectively considered as selected channels sCh1, sCh2 and sCh3 in interval T5.

As shown in FIG. 9B, the interference areas 18a and 18b do not overlap any of the data packets aDT1 to aDT8 and bDT1 to bDT7 in intervals T1 to T5. This implies that the slave devices can successfully acquire their corresponding data packets. Therefore, the number of data packets that can be successfully received is increased dramatically and the throughput is increased.

For the one-to-many scheme, an exemplary allocation of selected channels sCh1, sCh2 and sCh3 and data packets in intervals T1 to T5 are summarized in Table 3. Please refer to FIGS. 9A and 9B and Table 3 together.

TABLE 3

| | interval | | | | |
|---|---|---|---|---|---|
| selected channel | T1 | T2 | T3 | T4 | T5 |
| sCh1 | bDT1 | bDT2 | aDT4 | bDT6 | aDT8 |
| sCh2 | aDT1 | bDT3 | bDT5 | aDT5 | bDT7 |
| sCh3 | aDT2 | aDT3 | bDT4 | aDT6 | aDT7 |

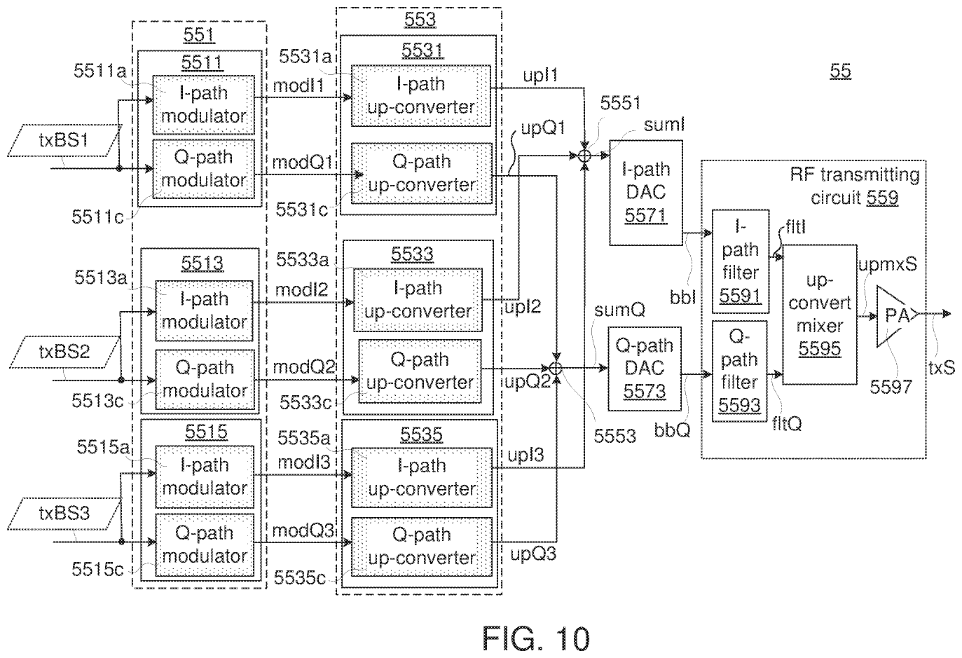

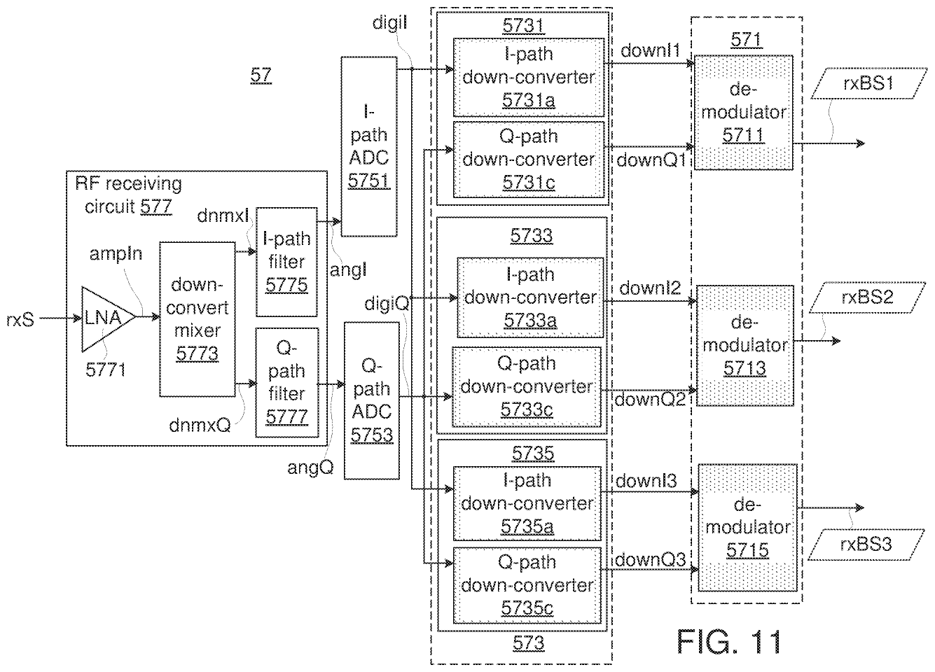

FIG. 10 shows a Bluetooth transmitter 55 in a master device, and FIG. 11 shows a Bluetooth receiver 57 in a slave device. In practical applications, a Bluetooth device might occasionally be used as a master device or a slave device. Therefore, a Bluetooth device might integrate the Bluetooth transmitter 55 and the Bluetooth receiver 57 together. In some embodiments, the Bluetooth transmitter 55 and the Bluetooth receiver 57 are integrated in a single integrated circuit. To integrate both the Bluetooth transmitter 55 and the Bluetooth receiver 57, a switch is required to allow an antenna to selectively connect to the Bluetooth transmitter 55 or the Bluetooth receiver 57.

FIG. 10 is a block diagram illustrating the internal components of the Bluetooth transmitter according to an embedment of the present disclosure. A Bluetooth controller simultaneously transmits transmission bitstreams txBS1, txBS2 and txBS3 to the transmitter 55, wherein the transmission bitstreams txBS1, txBS2 and txBS3 respectively correspond to data packets being transmitted on the selected channels sCh1, sCh2, and sCh3 in intervals T1 to T5.

For example, the transmission bitstream txBS1 in interval T1 may carry data packet DT11 in FIGS. 5A, 5B, 6A and 6B, or carry data packet bDT1 in FIGS. 9A and 9B. Or, the transmission bitstream txBS1 in interval T2 may carry data packet DT21 in FIGS. 5A, 5B, 6A and 6B, or carry data packet bDT2 in FIGS. 9A and 9B. Similarly, the transmission bitstream txBS2 in interval T1 may carry data packet DT12 in FIGS. 5A, 5B, 6A and 6B, or carry data packet aDT1 in FIGS. 9A and 9B. The relationships between the transmission bitstreams txBS1, txBS2, and txBS3, the data packets and intervals are not repetitively described.

The transmitter 55 includes a modulation stage 551, an up-conversion stage 553, an I-path summer 5551, a Q-path summer 5553, an I-path digital-to-analog converter (hereinafter, DAC) 5571, a Q-path DAC 5573, and an RF transmitting circuit 559. In some embodiments, the modulation stage 551, the up-conversion stage 553, the I-path summer 5551, and the Q-path summer 5553 are implemented with digital circuits, and the I-path DAC 5571 and the Q-path DAC 5573 are implemented with analog circuits.

The modulation stage 551 includes modulation modules 5511, 5513 and 5515, and the up-conversion stage 553 includes up-conversion modules 5531, 5533 and 5535. The modulation module 5511 and the up-conversion module 5531 correspond to the selected channel sCh1, the modulation module 5513 and the up-conversion module 5533 correspond to the selected channel sCh2, and the modulation module 5515 and the up-conversion module 5535 correspond to the selected channel sCh3.

Each of the modulation modules 5511, 5513 and 5515 includes an I-path modulator 5511a, 5513a and 5515a and a Q-path modulator 5511c, 5513c and 5515c. Each of the up-conversion modules 5531, 5533 and 5535 includes an I-path up-converter 5531a, 5533a and 5535a and a Q-path up-converter 5531c, 5533c and 5535c.

In the modulation module 5511, the I-path modulator 5511a and the Q-path modulator 5511c receive the transmission bitstream txBS1 from the Bluetooth controller and jointly generate a pair of modulated signals (modI1 and modQ1). The I-path modulator 5511a modulates the transmission bitstream txBS1 with an I-path carrier signal to generate an I-path modulated signal modI1, and the Q-path modulator 5511c modulates the transmission bitstream txBS1 with a Q-path carrier signal to generate a Q-path modulated signal modQ1. The I-path carrier signal and the Q-path carrier signal have a 90° phase shift.

Similarly, the I-path modulator 5513a and the Q-path modulator 5513c in the modulation module 5513 jointly generate a pair of modulated signals (modI2 and modQ2) based on an I-path carrier signal and a Q-path carrier signal, wherein the I-path carrier signal and the Q-path carrier signal have a 90° phase shift. The I-path modulator 5515a and the Q-path modulator 5515c in the modulation module 5515 jointly generates a pair of modulated signals (modI3 and modQ3) based on an I-path carrier signal and a Q-path carrier signal, wherein the I-path carrier signal and the Q-path carrier signal have a 90° phase shift.

In the up-conversion module 5531, the I-path up-converter 5531a and the Q-path up-converter 5531c jointly convert the pair of modulated signals (modI1 and modQ1) to a pair of up-converted signals (upI1 and upQ1), wherein the pair of up-converted signals (upI1 and upQ1) are 20 corresponding to the selected channel sCh1. The I-path up-converter 5531a up-converts the I-path modulated signal modI1 to an I-path up-converted signal upI1, and the Q-path up-converter 5531c up-converts the Q-path modulated signal modQ1 to a Q-path up-converted signal upQ1.

Similarly, each of the up-conversion modules 5533 and 5535 generates a pair of up-converted signals (upI2 and upQ2) and (upI3 and upQ3). The pair of up-converted signals (upI2 and upQ2) are corresponding to the selected channel sCh2, and the pair of up-converted signals (upI3 and upQ3) are corresponding to the selected channel sCh3. As the design and operations of the up-conversion modules 5531, 5533 and 5535 are similar, detailed descriptions about the I-path up-converters 5533a and 5535a and the Q-path up-converters 5533c and 5535c are omitted.

The I-path summer 5551 receives the I-path up-converted signals upI1, upI2 and upI3 from the I-path up-converters 5531a, 5533a and 5535a, respectively. Then, the I-path summer 5551 generates an I-path summer output suml by summing the I-path up-converted signals upI1, upI2 and upI3. The I-path summer output suml is further transmitted to the I-path DAC 5571, and the I-path DAC 5571 converts the I-path summer output suml to an I-path baseband signal bbI.

The Q-path summer 5553 receives the Q-path up-converted signals upQ1, upQ2 and upQ3 from the Q-path up-converters 5531c, 5533c and 5535c, respectively. Then, the Q-path summer 5553 generates a Q-path summer output sumo by summing the Q-path up-converted signals upQ1, upQ2 and upQ3. The Q-path summer output sumQ is further transmitted to the Q-path DAC 5573, and the Q-path DAC 5573 converts the Q-path summer output sumQ to a Q-path baseband signal bbQ.

The RF transmitting circuit 559 includes an I-path filter 5591, a Q-path filter 5593, an up-convert mixer 5595, and a power amplifier (hereinafter, PA) 5597. Both the up-convert mixer 5595 and the PA 5597 are single in quantity. The I-path filter 5591 is electrically connected to the I-path DAC 5571 and the up-convert mixer 5595, and the Q-path filter 5593 is electrically connected to the Q-path DAC 5573 and the up-convert mixer 5595. The PA 5597 is electrically connected to the up-convert mixer 5595 and selectively electrically connected to an antenna.

The I-path filter 5591 receives and filters the I-path baseband signal bbI to generate an I-path filtered signal fltI. The Q-path filter 5593 receives and filters the Q-path baseband signal bbQ to generate a Q-path filtered signal fltQ. Then, the up-convert mixer 5595 mixes the I-path filtered signal fltI and the Q-path filtered signal fltQ to generate an up-mixed baseband signal upmxS. The PA 5597 generates the output signal txS by increasing the signal power of the up-mixed baseband signal upmxS. After passing through the PA 5597, the output signal txS is sent to the antenna, such as the antenna 41e, which propagates the radio waves in the air.

Although the present disclosure uses multiple up-conversion modules and multiple modulation modules to implement multiple data channels for data transmission, the multiple up-conversion modules and the multiple modulation modules jointly use a single mixer and a single PA. That is, a quantity of each of mixers and PAs required for transmitting data with multiple data channels is equal to that in an application for transmitting data with a single data channel. The quantity of each of mixers and PAs is not increased even if a quantity of data channels is increased. Alternatively speaking, the data throughput is increased without increasing area cost significantly.

FIG. 11 is a block diagram illustrating the internal components of the Bluetooth receiver according to an embedment of the present disclosure. The receiver 57 includes a demodulation stage 571, a down-conversion stage 573, an I-path analog-to-digital converter (hereinafter, ADC) 5751, a Q-path ADC 5753, and an RF receiving circuit 577. The RF receiving circuit 577 receives the input signal rxS transmitted on the selected channels sCh1, sCh2 and sCh3. In some embodiments, the demodulation stage 571 and the down-conversion stage 573 are implemented with digital circuits, and the I-path ADC 5751 and the Q-path ADC 5753 are implemented with analog circuits.

The demodulation stage 571 includes de-modulators 5711, 5713 and 5715, and the down-conversion stage 573 includes down-conversion modules 5731, 5733 and 5735. In practical applications, the number of down-conversion modules and the number of de-modulators are changed with the number of selected channels.

Each of the down-conversion modules 5731, 5733 and 5735 includes an I-path down-converter 5731a, 5733a and 5735a and a Q-path down-converter 5731c, 5733c and 5735c. The de-modulator 5711 and the down-conversion module 5731 correspond to the selected channel sCh1; the de-modulator 5713 and the down-conversion module 5733 correspond to the selected channel sCh2; the de-modulator 5715 and the down-conversion module 5735 are corresponding to the selected channel sCh3.

The RF receiving circuit 577 includes a low noise amplifier (hereinafter, LNA) 5771 a down-convert mixer 5773, an I-path filter 5775, and a Q-path filter 5777. Both the down-convert mixer 5773 and the LNA 5771 are single in quantity. The LNA 5771 is connected to an antenna when the receiver 57 is enabled. The down-convert mixer 5773 is electrically connected to the LNA 5771, the I-path filter 5775, and the Q-path filter 5777. The I-path filter 5775 is electrically connected to the I-path ADC 5751, and the Q-path filter 5777 is electrically connected to the Q-path ADC 5753.

The LNA 5771 receives the input signal rxS from the antenna and generates an amplified input signal ampIn accordingly. With the LNA 5771, the noise of the subsequent stages can be reduced. The down-convert mixer 5773 converts the amplified input signal ampIn to generate an I-path down-mixed signal dnmxI and a Q-path down-mixed signal dnmxQ. The I-path filter 5775 filters the I-path down-mixed signal dnmxI to generate an I-path analog filtered signal angI, and the Q-path filter filters the Q-path down-mixed signal dnmxQ to generate a Q-path analog filtered signal angQ.

The I-path ADC 5751 is electrically connected to the I-path filter 5775 and the I-path down converters 5731a, 5733a and 5735a. The Q-path ADC 5753 is electrically connected to the Q-path filter 5777 and the Q-path down converters 5731c, 5733c and 5735c. The I-path ADC 5751 converts the I-path analog filtered signal angI to an I-path digital filtered signal digiI, and the Q-path ADC 5753 converts the Q-path analog filtered signal angQ to a Q-path digital filtered signal digiQ. The I-path digital filtered signal digiI is transmitted to the I-path down-converters 5731a, 5733a and 5735a, and the Q-path digital filtered signal digiQ is transmitted to the Q-path down-converters 5731c, 5733c and 5735c.

In the down-conversion module 5731, the I-path down-converter 5731a converts the I-path digital filtered signal digiI to an I-path down-converted signal downI1, and transmits the I-path down-converted signal downI1 to the de-modulator 5711. The I-path down-converted signal downI1 carries data packets transmitted on the selected channels sCh1, sCh2 and sCh3. Moreover, the Q-path down-converter 5731c converts the Q-path digital filtered signal digiQ to a Q-path down-converted signal downQ1, and transmits the Q-path down-converted signal downQ1 to the de-modulator 5711. The Q-path down-converted signal downQ1 carries data packets transmitted on the selected channels sCh1, sCh2 and sCh3.

Similarly, in the down-conversion module 5733, the I-path down-converter 5733a converts the I-path digital filtered signal digiI to an I-path down-converted signal downI2, and the Q-path down-converter 5733c converts the Q-path digital filtered signal digQ to a Q-path down-converted signal downQ2, The I-path down-converted signal downI2 carries data packets transmitted on the selected channels sCh1, sCh2 and sCh3. Also, the Q-path down-converted signal downQ2 carries data packets transmitted on the selected channels sCh1, sCh2 and sCh3.

In the down-conversion module 5735, the I-path down-converter 5735a converts the I-path digital filtered signal digiI to an I-path down-converted signal downI3, and the Q-path down-converter 5735c converts the Q-path digital filtered signal digQ to a Q-path down-converted signal downQ3. The I-path down-converted signal downI3 carries data packets transmitted on the selected channels sCh1, sCh2 and sCh3. Also, the Q-path down-converted signal downQ3 carries data packets transmitted on the selected channels sCh1, sCh2 and sCh3.

Then, the de-modulator 5711 provides a received bitstream rxBS1 by demodulating the I-path down-converted signal downI1 and the Q-path down-converted signal downQ1. That is, the de-modulator 5711 provides the received bitstream rxBS1 including a data packet transmitted on the selected channel sCh1 only by, for example, a filtering operation, and the received bitstream rxBS1 excludes data packets transmitted on the selected channels sCh2 and sCh3.

Similarly, the de-modulator 5713 provides a received bitstream rxBS2 by demodulating the I-path down-converted signal downI2 and the Q-path down-converted signal downQ2. That is, the de-modulator 5713 provides the received bitstream rxBS2 including a data packet transmitted on the selected channel sCh2 only by, for example, a filtering operation, and the received bitstream rxBS2 excludes data packets transmitted on the selected channels sCh1 and sCh3. The de-modulator 5715 provides a received bitstream rxBS3 by demodulating the I-path down-converted signal downI3 and the Q-path down-converted signal downQ3. That is, the de-modulator 5715 provides the received bitstream rxBS3 including a data packet transmitted on the selected channel sCh3 only by, for example, a filtering operation, and the received bitstream rxBS3 excludes data packets transmitted on the selected channels sCh1 and sCh2.

The received bitstream rxBS1 corresponds to data packets being transmitted on the selected channel sCh1 in intervals T1 to T5. For example, the received bitstream rxBS1 in interval T1 may carry data packet DT11 in FIGS. 5A, 5B, 6A and 6B, or carry data packet bDT1 in FIGS. 9A and 9B. Or, the received bitstream rxBS1 in interval T2 may carry data packet DT21 in FIGS. 5A, 5B, 6A and 6B, or carry data packet bDT2 in FIGS. 9A and 9B. Similarly, the received bitstream rxBS2 in interval T1 may carry data packet DT12 in FIGS. 5A, 5B, 6A and 63, or carry data packet aDT1 in FIGS. 9A and 9B. The relationships between the received bitstreams rxBS1, rxBS2 and rxBS3, the data packets and intervals are not repetitively described.

The Bluetooth receiver 57 can be applied to the one-to-one scheme and the one-to-many scheme. In the one-to-many scheme, in an embodiment, the input signal rxS carries data packets belonging to different slave devices. For such applications, the Bluetooth receiver 57 may perform a preliminary filter operation to filter the components simultaneously carried by the input signal rxS but corresponding to other slave devices. In practical applications, phase-detection circuits can be placed between the I-path ADC 5751 and the down-conversion modules 5731 5733 and 5735, and between the Q-path ADC 5753 and the down-conversion modules 5731, 5733 and 5735 to proceed the preliminary filter operation.

As illustrated above, the selected channels sCh1, sCh2 and sCh3 are re-selected in each interval T1 to T5. Therefore, the data channels corresponding to the selected channels sCh1, sCh2 and sCh3 are not necessary to be identical in different intervals T1 to T5. As the selected channels sCh1, sCh2 and sCh3 are dynamically selected in each interval T1 to T5, the signal relationships and the components in FIGS. 10 and 11 are controlled and operate on a per-interval base.

The modulation and the demodulation operations are based on Gaussian frequency-shift keying (hereinafter, GFSK) modulation. The modulation modules 5511, 5513 and 5515 and the up-conversion modules 5531, 5533 and 5535 in FIG. 10A, and the de-modulators 5711, 5713 and 5715 and the down-conversion modules 5731, 5733 and 5735 in FIG. 10B are implemented by digital circuits. Although the present disclosure selects more data channels for data transmission, the circuit complexities of the transmitter and receiver are not increased, and the area cost increases insignificantly because the modulation, demodulation, up-conversion and the down-conversion are implemented with digital circuits.

In further detail, although the present disclosure uses multiple down-conversion stages and multiple demodulation stages to implement multiple data channels for data transmission, the multiple down-conversion stages and the multiple demodulation stages share a single mixer and a single LNA. That is, a quantity of each of mixers and LNAs in multiple data channels is equal to that in an application of a single data channel. The quantity of each of mixers and LNAs is not increased as a quantity of data channels is increased. The data throughput is increased without increasing area cost significantly.

As illustrated above, the interference areas 18a and 18b might overlap the data channels and affect the quality and efficiency of data transmission. To reduce the impact caused by the interferences, the master device could transmit multiple data packets in a simultaneous manner. The illustrations above include embodiments for the one-to-one scheme, embodiments for the one-to-many scheme, the design of the transmitter in the master device, and the design of the receiver in the slave device. As the Bluetooth devices are capable of simultaneously transmitting data packets at different data channels in one interval, the chance of successfully receiving the data packets is dramatically raised.

For the one-to-one scheme, the slave device can still receive some of the data packets even if some of the data packets are missing. By doing so, the slave device in audio applications can continuously play the audio bitstream based on the partially received data packets, even if some of the data packets are disturbed. For the one-to-many scheme, more than one slave device can receive its corresponding data packets at the same time. Even if the interference exists and disturbs some of the data packets, the rest undisturbed data packets can still be received, and the data transmission rate can be improved. For both one-to-one scheme and one-to-many scheme, the number of analog circuits (e.g., power amplifier, LNA, or mixer) whose area cost is relatively high is not increased although the number of data channels is increased. In summary, the data throughput is increased without increasing area cost significantly.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A Bluetooth transmitter, comprising;
a modulation stage, comprising:
a first modulation module corresponding to a first selected channel, configured to modulate a first transmission bitstream to generate a first first-path modulated signal and a first second-path modulated signal; and
a second modulation module corresponding to a second selected channel, configured to modulate a second transmission bitstream to generate a second first-path modulated signal and a second second-path modulated signal;
an up-conversion stage, comprising:
a first up-conversion module corresponding to the first selected channel, electrically connected to the first modulation module, configured to up-convert the first first-path modulated signal to a first first-path up-converted signal, and up-convert the first second-path modulated signal to a first second-path up-converted signal; and
a second up-conversion module corresponding to the second selected channel, electrically connected to the second modulation module, configured to up-convert the second first-path modulated signal to a second first-path up-converted signal, and up-convert the second second-path modulated signal to a second second-path up-converted signal;
a first-path digital-to-analog converter, configured to generate a first-path baseband signal based on the first first-path up-converted signal and the second first-path up-converted signal;
a second-path digital-to-analog converter, configured to generate a second-path baseband signal based on the first second-path up-converted signal and the second second-path up-converted signal; and
a radio frequency transmitting circuit, electrically connected to the first-path digital-to-analog converter and the second-path digital-to-analog converter, configured to generate an output signal based on the first-path baseband signal and the second-path baseband signal, wherein the output signal carries a plurality of data packets in a plurality of intervals.

2. The Bluetooth transmitter according to claim 1, wherein the plurality of intervals comprises a first interval and a second interval, wherein
the first selected channel in the first interval corresponds to a first-first radio frequency,
the first selected channel in the second interval corresponds to a second-first radio frequency,
the second selected channel in the first interval corresponds to a first-second radio frequency, and
the second selected channel in the second interval corresponds to a second-second radio frequency.

3. The Bluetooth transmitter according to claim 2, wherein,
the first-first radio frequency is different from the first-second radio frequency, and
the second-first radio frequency is different from the second-second radio frequency.

4. The Bluetooth transmitter according to claim 2, wherein
the first-first radio frequency is different from the second-first radio frequency, and
the first-second radio frequency is different from the second-second radio frequency.

5. The Bluetooth transmitter according to claim 1, wherein the first transmission bitstream and the second transmission bitstream correspond to a first slave device.

6. The Bluetooth transmitter according to claim 1, wherein the first transmission bitstream corresponds to a second slave device, and the second transmission bitstream corresponds to a third slave device.

7. The Bluetooth transmitter according to claim 1, further comprising:
a first-path summer, electrically connected to the first up-conversion module, the second up-conversion module, and the first-path digital-to-analog converter, configured to sum the first first-path up-converted signal and the second first-path up-converted signal and generate a first-path summer output; and
a second-path summer, electrically connected to the first up-conversion module, the second up-conversion module, and the second-path digital-to-analog converter, configured to sum the first second-path up-converted signal and the second second-path up-converted signal and generate a second-path summer output, wherein,
the first-path digital-to-analog converter converts the first-path summer output to the first-path baseband signal, and
the second-path digital-to-analog converter converts the second-path summer output to the second-path baseband signal.

8. The Bluetooth transmitter according to claim 1, wherein the first modulation module comprises:
a first firs-path modulator, electrically connected to the first up-conversion module, configured to modulate the first transmission bitstream with a first first-path carrier signal to generate the first first-path modulated signal; and
a first second-path modulator, electrically connected to the first up-conversion module, configured to modulate the first transmission bitstream with a first second-path carrier signal to generate the first second-path modulated signal, wherein the first first-path carrier signal and the first second-path carrier signal have a 90° phase shift.

9. The Bluetooth transmitter according to claim 8, wherein the second modulation module comprises:
a second firs-path modulator, electrically connected to the second up-conversion module, configured to modulate the second transmission bitstream with a second first-path carrier signal to generate the second first-path modulated signal; and
a second second-path modulator, electrically connected to the second up-conversion module, configured to modulate the second transmission bitstream with a second second-path carrier signal to generate the second second-path modulated signal, wherein the second first-path carrier signal and the second second-path carrier signal have another 90° phase shift.

10. The Bluetooth transmitter according to claim 8, wherein the first up-conversion module comprises:
a first first-path up-converter, electrically connected to the first firs-path modulator, configured to up-convert the first first-path modulated signal to the first first-path up-converted signal: and
a first second-path up-converter, electrically connected to the second firs-path modulator, configured to up-convert the first second-path modulated signal to the first second-path up-converted signal.

11. A Bluetooth receiver, comprising:
a radio frequency receiving circuit, configured to receive an input signal and transform the input signal to a first-path analog filtered signal and a second-path analog filtered signal, wherein the input signal carries a plurality of data packets in a plurality of intervals;
a first-path analog-to-digital converter, electrically connected to the radio frequency receiving circuit, configured to convert the first-path analog filtered signal to a first-path digital filtered signal;
a second-path analog-to-digital converter, electrically connected to the radio frequency circuit, configured to convert the second-path analog filtered signal to a second-path digital filtered signal;
a down-conversion stage, comprising:
a first down-conversion module corresponding to a first selected channel, electrically connected to the first-path analog-to-digital converter and the second-path analog-to-digital converter, configured to down-convert the first-path digital filtered signal to a first first-path down-converted signal, and down-convert the second-path digital filtered signal to a first second-path down-converted signal; and
a second down-conversion module corresponding to a second selected channel, electrically connected to the first-path analog-to-digital converter and the second-path analog-to-digital converter, configured to down-convert the first-path digital filtered signal to a second first-path down-converted signal, and down-convert the second-path digital filtered signal to a second second-path down-converted signal; and
a demodulation stage, comprising:
a first de-modulator corresponding to the first selected channel, electrically connected to the first down-conversion module, configured to provide a first received bitstream based on the first first-path down-converted signal and the first second-path down-converted signal; and
a second de-modulator corresponding to the second selected channel, electrically connected to the second down-conversion module, configured to provide a second received bitstream based on the second first-path down-converted signal and the second second-path down-converted signal.

12. The Bluetooth receiver according to claim 11, wherein the plurality of intervals comprises a first interval and a second interval, wherein
the first selected channel in the first interval corresponds to a first-first radio frequency,
the first selected channel in the second interval corresponds to a second-first radio frequency,
the second selected channel in the first interval corresponds to a first-second radio frequency, and
the second selected channel in the second interval corresponds to a second-second radio frequency.

13. The Bluetooth receiver according to claim 12, wherein
the first-first radio frequency is different from the first-second radio frequency, and
the second-first radio frequency is different from the second-second radio frequency.

14. The Bluetooth receiver according to claim 12, wherein
the first-first radio frequency is different from the second-first radio frequency, and
the first-second radio frequency is different from the second-second radio frequency.

15. The Bluetooth receiver according to claim 11, wherein the first down-conversion module comprises:
a first first-path down-converter, electrically connected to the first-path analog-to-digital converter and the first de-modulator, configured to down convert the first-path digital filtered signal to the first first-path down-converted signal; and
a second first-path down-converter, electrically connected to the second-path analog-to-digital converter and the first de-modulator, configured to down-convert the second-path digital filtered signal to the first second-path down-converted signal.

16. The Bluetooth receiver according to claim 11, herein the first received bitstream and the second received bitstream correspond to the Bluetooth receiver.

17. The Bluetooth receiver according to claim 11, wherein one of the first received bitstream and the second received bitstream corresponds to the Bluetooth receiver, and the other of the first received bitstream and the second received bitstream corresponds to another Bluetooth receiver.

18. A receiver, comprising:
a radio frequency circuit, configured to receive an input signal originated from radio waves transmitted on a first channel and a second channel;
a first de-modulator, configured to provide a first bitstream based on a first data packet transmitted on the first channel and without a second data packet transmitted on the second channel; and
a second de-modulator, configured to provide a second bitstream different from the first bitstream based on the second data packet transmitted on the second channel and without the first data packet transmitted on the first channel.

19. The receiver according to claim 8, wherein the radio frequency circuit comprises:
a mixer, configured to generate a mixed signal, wherein the first de-modulator provides the first bitstream based on the mixed signal, and the second de-modulator provides the second bitstream based on the mixed signal.

20. The receiver according to claim 19, wherein the mixer is single.
